(19) United States
(12) Patent Application Publication
(10) Pub. No.: US 2007/0178127 A1
(43) Pub. Date: Aug. 2, 2007

(54) Agrochemical bird repellent and method

(75) Inventor: Nina Wilson, Yuma, AZ (US)

Correspondence Address: QUARLES & BRADY LLP, ONE SOUTH CHURCH AVENUE, SUITE 1700, TUCSON, AZ, 85701-1621, US

(73) Assignee: Gowan Company, L.L.C., Yuma, AZ (US)

(21) Appl. No.: 11/343,396

(22) Filed: Jan. 31, 2006

(51) Int. Cl. A01N 37/18; A01N 25/08

(52) U.S. Cl. 424/405; 424/410; 514/617

(57) ABSTRACT

Formulations and methods of bird aversion including flutolanil are provided. Birds are repelled by treating a bird-consumption product with a formulation that includes an effective amount of flutolanil, which formulation typically ranges from between 0.25 to 2 percent weight/weight of flutolanil.

### BACKGROUND OF THE INVENTION

1. Field of the Invention

The present invention concerns chemical repellents, and, more particularly, agricultural chemical formulations that render seeds, seedlings and other plant parts less palatable to birds through compositions and methods involving flutolanil.

2. Description of the Related Art

Several species of blackbirds, particularly red-winged blackbirds (Agelaius phoeniceus), common grackles (Quiscalus quiscula), and brown-headed cowbirds (Molothrus ater) cause extensive damage to newly planted and ripening rice in the United States. Indeed, annual losses to rice growers have been estimated to be in the tens-of-millions of dollars. In Texas alone, blackbird damage to newly seeded rice is estimated to be $4.2 million annually (Decker and Avery 1990). In Louisiana, blackbird damage to newly planted rice can be locally severe (Wilson 1985). Some growers report 100% loss and replanting is required. However, damage is not uniformly distributed, but is localized and proportional to the size of the nearby bird roost.

The blackbird damage problem has generated much concern in rice-producing states such as Louisiana, Texas, California, Arkansas and Missouri, and considerable public support exists for developing more effective management methods for reducing damage caused by birds. Many state rice grower's associations, extension agents, USDA Wildlife Services, and the National Wildlife Research Center consider resolving bird damage to rice as a high priority. In fact, USDA Research Needs Assessments in 1992, 1996, and 2001 placed a high priority on understanding and finding solutions to resolving blackbird/agriculture problems.

Moreover, while rice is one of the more intensely studied crops, there are a vast number of seeds, seedlings, other parts of a crop, or locations that need protection from known bird damage problems. Economic loss due to bird damage occurs in a variety of crops, including, but not limited to rice, lettuce seedlings, corn, sunflowers, fruits and nuts. Birds damage edible fruit as well as feed on seeds and seedlings. They can also be severe nuisance pests in recreational parks, business parks and buildings. Gatherings of birds are also considered hazardous for aircraft, particularly in or around runways.

Sometimes growers will resort to hazing methods, which entails frightening the birds with loud noises from shot guns or noise cannons. These non-lethal methods of bird control are expensive and often ineffective because it is difficult to predict areas of potential infestation. Thus, there continues to be a need for more effective management of bird-related problems.

### SUMMARY OF THE INVENTION

The invention generally relates to bird repellents and aversion methods involving benzanilides, such as flutolanil. In one aspect, the invention includes methods for repelling birds including the steps of treating seeds, seedlings, other plant parts, or bird consumables such as bait with flutolanil.

In another aspect of the invention, formulations of the present invention that provide stable compositions of flutolanil agents alone and in admixture with other agriculturally beneficial agents, which include, but are not limited to, baits, bait grain, adjuvants, herbicidal agents (including herbicide plant growth regulating agents), insecticidal agents, fungicidal agents, and other pesticides are disclosed.

Various other purposes and advantages of the invention will become clear from its description in the specification that follows. Therefore, to the accomplishment of the objectives described above, this invention includes the features hereinafter fully described in the detailed description of the preferred embodiments, and particularly pointed out in the claims. However, such description discloses only some of the various ways in which the invention may be practiced.

### BRIEF DESCRIPTION OF THE DRAWINGS

FIG. 1 depicts the average (±SE) rice consumption among red-winged blackbirds offered untreated rice and rice treated with flutolanil 1%. Pretreatment (“pretrt”) and test data (“test) reflect consumption among all birds (n =20) from each of two bowls. Post-test (“posttest”) data reflect overall consumption among birds offered untreated or treated rice (n=10 birds per group). Study days are indicated by the numerals 1-4 below or next to the “pretrt,” “test,” or “post test” labels.

FIG. 2 illustrates the average (±SE) repellency associated with five concentrations of the flutolanil composition “GWN-4770”, which is FLUTOLANIL 70% GRANULE (n=8 birds per group). Repellency represents test (day 1) consumption relative to average pretreatment consumption.

FIG. 3 shows the average (±SE) rice consumption among red-winged blackbirds offered one of five concentrations of the flutolanil composition FLUTOLANIL 70% GRANULE (n=8 birds per group). All birds were offered one bowl of untreated rice during the pretreatment and post-test. Study days are indicated by the numerals 1-4 above the “pretrt” (pretreatment), “test” or “post test” conditions.

FIG. 4. depicts the average seeds (±SE) unconsumed by blackbirds on lanes baited with treated (2% FLUTOLANIL 70% GRANULE) and untreated rice in southwestern Louisiana (n=5 study sites).

### DETAILED DESCRIPTION OF THE PREFERRED EMBODIMENTS

The invention relates generally to compositions and processes that involve agrochemical repellent preparations including flutolanil. In one aspect of the invention, a method of bird aversion is provided that includes repelling a bird by treating a bird-consumption product with a formulation having an effective amount of flutolanil. The bird-consumption product may be a seed, such as for rice, peanuts, and potatoes, a seedling, a fruit or vegetable, or other bird consumption product.

In another aspect of the invention, flutolanil formulations are provided that include between 0.25 to 2 percent weight/weight of flutolanil, either alone or in admixture with one or more agrochemical agents, such as pesticides, fertilizers, adjuvants, anti-transpirants, and the like.

While flutolanil is a well-known fungicide, its efficacy in a method of bird aversion is surprising and is believed to be unknown prior to the present invention. For example, one aspect of the novelty and surprising effectiveness of the invention in its application to rice lay in the timing of treatment, which is performed prior to planting (for seeds) or on young seedlings. This is in contrast to the fungicidal use of flutolanil on rice, which is recommended for application 50-70 days after planting.

Importantly, the methods of the invention are thought to result in a learned or so-called secondary repellency behavior, indicating that the bird-consumption products treated according to the invention are found to be less palatable by birds that then communicate this to other birds. This non-lethal effect is preferred as it tends to have the least impact on the environment and tends to be least objectionable to the general public.

### EXAMPLES

The present invention is further illustrated by the following non-limiting examples. The flutolanil formulation used in the following was FLUTOLANIL 70% GRANULE, which is composed of the following: 70% flutolanil by weight, 12% formulation adjuvants (e.g., 9% w/w of a blend of dispersing and suspending agents, 1% dispersing clay, 2% water), and 18% clay. However, other formulations may be used, such as, for example, flutolanil 4SC, a suspension concentrate containing 43% flutolanil weight/weight, 14% formulation adjuvants (6.1% dispersing and suspending agent, 1% clay structuring agent, 0.06% xantham gum, 0.1% antimicrobial agent, 0.3% siliconic antifoam, and 6.0% glycol antifreezing agent) and 43% water. The liquid suspension concentrate formulation may be better adapted as a seed treatment as the properties will lend itself to uniform coating of the seed.

Utilizing conditions and procedures for controlled experiments and field studies that previously have been conducted to investigate the efficacy of candidate avian repellents for rice producers (Avery et al. 1998, 2005; Cummings et al. 2002; Werner et al. 2005), the present study was designed to evaluate FLUTOLANIL 70% GRANULE (a registered fungicide containing flutolanil) as a chemical repellent to reduce blackbird impacts to rice production. Two controlled feeding experiments were conducted at the Nation Wildlife Research Center (NWRC) Outdoor Animal Research Facility, and two field studies in southwestern Louisiana and southeastern Missouri. The results from these studies demonstrate FLUTOLANIL 70% GRANULE as an avian repellent.

Preference Testing with FLUTOLANIL 70% GRANULE

The preliminary evaluation of candidate repellents involves preference testing among caged blackbirds for repellent-treated and untreated seed rice. Preference testing involved three, 4-day testing periods (pretreatment, test, post-test). Twenty adult red-winged blackbirds (males) were captured near Fort Collins, Colo. and transported to the NWRC. After group quarantine, birds were transferred to individual cages (0.9×1.8×0.9 m) and were offered untreated seed rice and water (ad libitum) for 3-5 days. Following acclimation, the daily consumption of untreated rice (±0.1 g, including spillage) offered in two feed bowls was measured. All birds were again offered (ad libitum) untreated rice for three days following the pretreatment.

During preference testing, one bowl of untreated rice and one bowl of rice treated with 1% (wt/wt) FLUTOLANIL 70% GRANULE was offered to all birds. Treated rice was formulated by applying the treating solution (60 ml/kg) to 10 kg certified seed rice. Whereas the maximum label rate for FLUTOLANIL 70% GRANULE is 1.43 lb/ac, and USDA agricultural cooperators have typically planted 130 lb rice seed per acre, the treating solution included 110 g flutolanil 70% granule, 6 ml Transfilmg (PBI/Gordon, Kansas City, Mo.), and 484 ml water. Treated rice was processed using a rotating mixer and household spray equipment. The north-south positioning of treatments within individual cages was randomized on the first day, and alternated on subsequent days of the test. All birds were again offered (ad libitum) untreated rice for three days following the test.

All birds were randomly assigned to one of two treatment groups following the test. The randomization of group assignments was restricted based upon average rice consumption observed (per bird) during the test. Group A (n=10 birds) received two bowls of treated rice, and Group B (n=10) received two bowls of untreated rice during the post-test. Post-test consumption was measured to investigate the mode of action of the candidate repellent.

post-test consumption of untreated rice did not differ from overall consumption observed during pretreatment, then birds reflexively withdrew from the candidate repellent and may repeatedly sample rice subsequent to repellent exposure. Such withdrawal or escape behavior indicates activity of a sensory or so-called primary repellent (Werner and Clark 2003). If, however, post-test consumption of untreated rice was less than that observed during pretreatment, then birds avoided rice subsequent to repellent exposure and sampling was discontinued. Such avoidance indicates activity of a post-ingestive toxin, or secondary repellent (Werner and Clark 2003).

Daily rice consumption during the pretreatment, test, and post-test was used as the dependent measure for subsequent statistical analyses (ANOVA; SAS 1999). Rice consumption was compared between bowls (n=20 birds) during the pretreatment and testing periods to determine the efficacy of flutolanil 70% granule (period effect) and the period-by-treatment interaction. Overall rice consumption was compared between birds in Groups A and B (n=10 per group) during the pretreatment and post-test to determine repellent mode of action.

No-Choice Testing with FLUTOLANIL 70% GRANULE

No-choice tests were conducted to determine the dose-response relationship exhibited by birds offered rice treated with one of five concentrations of FLUTOLANIL 70% GRANULE. Forty adult red-winged blackbirds (males) were captured near Fort Collins, Colo. and transported to the NWRC. Following group quarantine, birds were transferred to individual cages and were offered (ad libitum) untreated seed rice in one bowl (north side of cage) and water (south side) for 3-5 days. Following acclimation, the daily consumption of untreated rice (±0.1 g, including spillage) offered in one feed bowl was measured. All birds were again offered (ad libitum) untreated rice for three days following the pretreatment.

All birds were randomly assigned to one of five treatment groups following the test. The randomization of group assignments was restricted based upon average rice consumption observed (per bird) during the pretreatment. Treatment groups (n=8 birds per group) included 0.25%, 0.5%, 0.75%, 1%, and 2% (wt/wt) FLUTOLANIL 70% GRANULE. Formulation procedures were the same as those implemented during the preference test. All birds were again offered (ad libitum) untreated rice for three days following the no-choice test. The daily consumption of treated and untreated rice during the test and post-test, respectively, was then measured.

Linear regression (SAS 1999) was used to analyze the dose-response relationship exhibited among treatment groups. The regression model related the concentration of FLUTOLANIL 70% GRANULE offered to blackbirds to the repellency observed during the no-choice test (i.e., test relative to pretreatment consumption). If FLUTOLANIL 70% GRANULE did not affect rice consumption, a non-significant slope of the dose-response relationship was expected (P>0.05). ANOVA (SAS 1999) was used to compare pretreatment and post-test rice consumption (period effect) and the period-by-treatment group interaction.

Field Evaluation of Broadcasted Seed

Five field sites (0.6-0.8 ha/site) near traditional blackbird roosting areas and/or under major flightlines emanating from those roosts were established in Vermilion and Cameron Parish, La. All sites had intermediate blackbird activity (˜200-400 birds/ha) throughout the study. Test sites were plowed, leveled, and made void of vegetation. Each site was pre-baited with untreated seed rice for three to five days to establish blackbird feeding activity. Rice was applied with ground equipment at a rate of 10 kg/lane on four lanes, 10 m wide by 50-70 m long. Lanes were separated by 25 meters.

Twenty kg of seed rice was treated with 2% FLUTOLANIL 70% GRANULE (wt/wt) and of the anti-transpirant 0.1% Transfilm® for each site. Treated seed rice was prepared by placing the rice seed in a mixer and spraying the rice at the appropriate application rate for 4 minutes as the mixer rotated. Treated rice seed was poured into a container and stored for less than 24 h before being broadcast onto the test sites. Following the pretreatment period, two lanes in each field were randomly selected for the treatment. The two remaining lanes were baited with untreated seed rice at the same rate as the treatments.

Ten permanent sampling plots (30×30 cm) were established along the center-line of each lane at each test site to estimate daily consumption of seed rice by blackbirds. Plots were placed systematically at 9 m intervals along the lane beginning with a random starting point between 1 and 9 m. Each plot was manipulated to contain 25 rice seeds that visually matched the surrounding density of broadcasted rice seed. Plots were assessed daily until all seed rice was consumed, blackbirds abandoned the test site, or until 3 days had elapsed. SAS (1999) was used to conduct the ANOVA associated with rice consumption at these sites.

Field Evaluation of Drilled Seed

Twelve test plots (3×50 m) were established within an experimental rice field near Malden, Mo. Plots were randomly assigned to one of two treatments. Six plots were drill-seeded with rice treated with 1% FLUTOLANIL 70% GRANULE (wt/wt) and 0.1% Transfilm®. Remaining plots were drill-seeded with untreated seed rice.

Eight subplots (0.5×0.5 m) were established within each plot. Four subplots were excluded from birds using woven wire. The remaining subplots (not excluded from birds) were used to estimate bird damage to treated and control seedlings. An ANOVA (SAS 1999) was used to compare seedling numbers among plots (treatment effect) and subplots (enclosure effect and treatment-by-enclosure interaction). Tukey post-hoc contrasts were used to separate means associated with significant (P≦0.05) ANOVA effects.

Results: Preference Testing with FLUTOLANIL 70% GRANULE

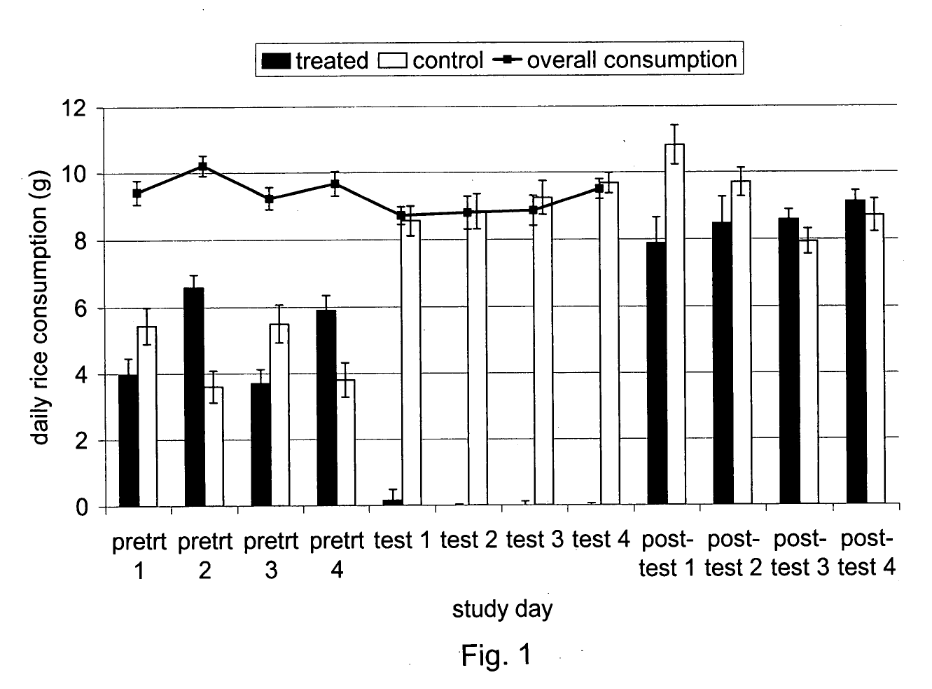

Blackbirds discriminated between untreated rice and rice treated with 1% FLUTOLANIL 70% GRANULE throughout the preference test (FIG. 1). Pretreatment rice consumption averaged 9.6 g (per bird, per day). On average, birds consumed 9.1 g of untreated rice and 0 g of treated rice during the test. No difference in overall rice consumption was observed during the pretreatment and test (F_{1.88}=2.18, P=0.14). However, a period-by-treatment interaction was observed during the preference test (F_{2.88}=418.35, P<0.001). Thus, blackbirds strongly preferred untreated rice during the test.

Overall rice consumption did not differ between the pretreatment and post-test periods (F_{1.22}=2.26, P=0.15). No period-by-treatment interaction was observed prior and subsequent to the preference test (F_{2.20}=1.94, P=0.17). Thus, red-winged blackbirds did not avoid untreated rice subsequent to FLUTOLANIL 70% GRANULE exposure (FIG. 1).

Results: No-Choice Testing with FLUTOLANIL 70% GRANULE

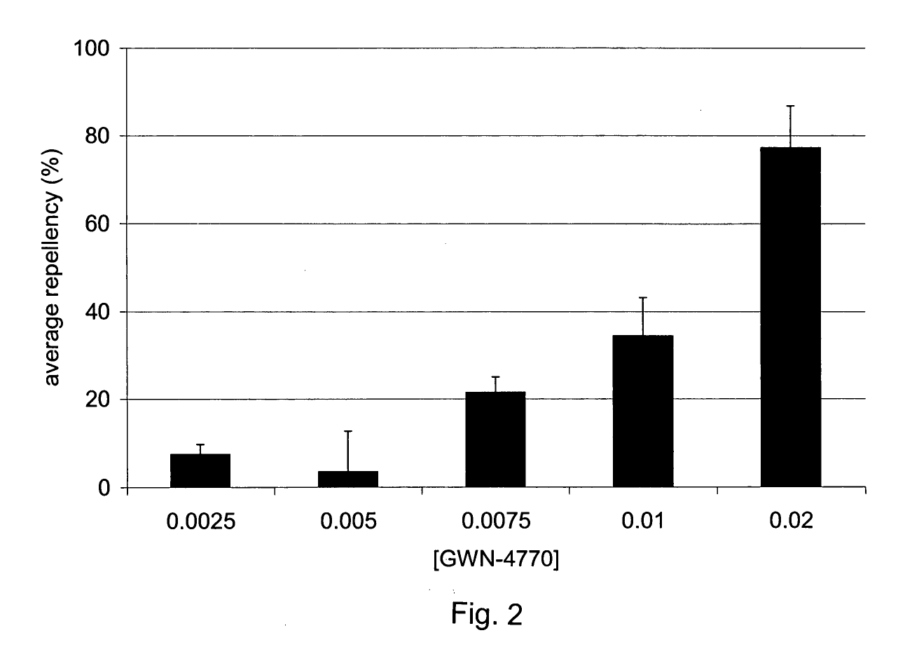

Relative to pretreatment rice consumption, red-winged blackbirds consumed 34% and 77% less rice treated with 1% and 2% FLUTOLANIL 70% GRANULE during the test, respectively (FIG. 2). A positive dose-response relationship was observed among concentrations of FLUTOLANIL 70% GRANULE on day 1 of the test (r²=0.60, P<0.001). Thus, rice consumption was inversely related to FLUTOLANIL 70% GRANULE concentration subsequent to the pretreatment.

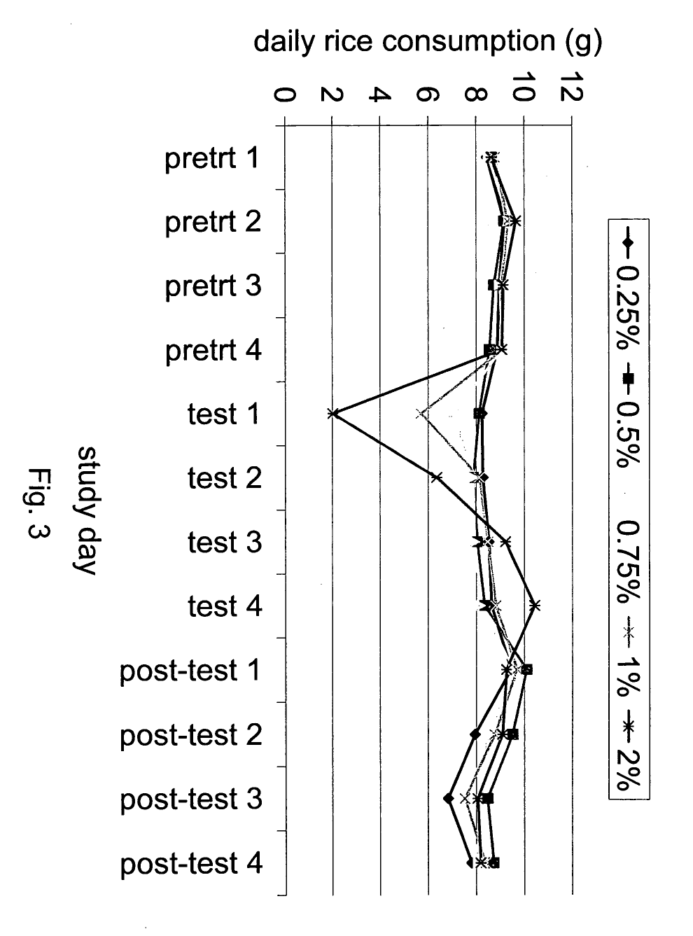

Rice consumption averaged 9.1 g (per bird, per day) during the pretreatment and 8.6 g during the post-test (F_{1.16}=4.42, P=0.05; FIG. 3). No period-by-treatment group interaction was observed prior and subsequent to the no-choice test (F_{8.56}=0.34, P=0.95). Thus, blackbird consumption of untreated rice subsequent to FLUTOLANIL 70% GRANULE exposure was unrelated to treatment concentrations.

Results: Field Evaluation of Broadcasted Seed

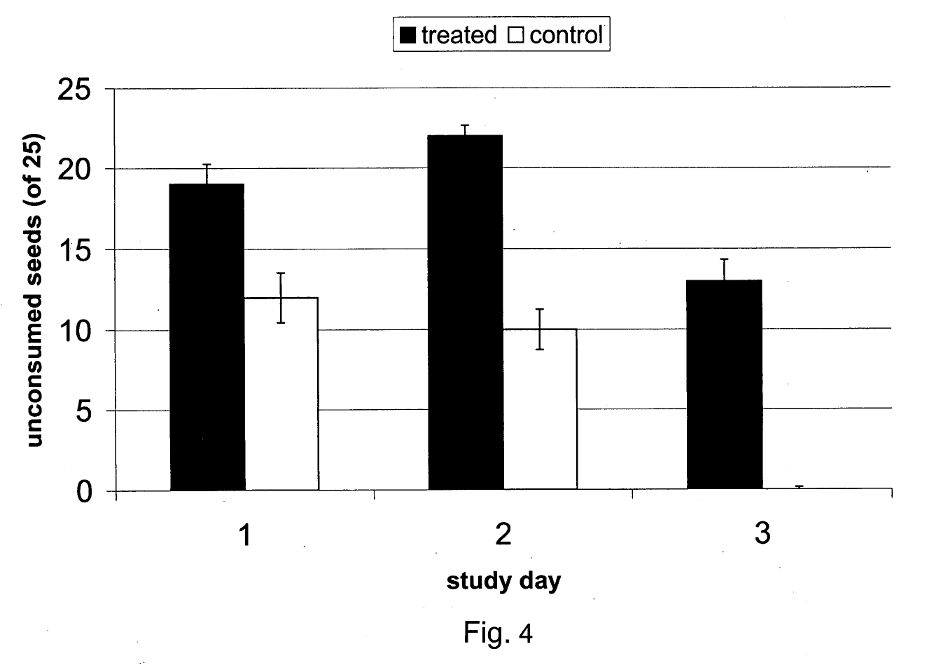

Blackbirds consumed more untreated rice than rice treated with 2% FLUTOLANIL 70% GRANULE (F_{1.8}=5.72, P=0.04; FIG. 4). Of 25 seeds placed on permanent plots within treated and control lanes, more than 70% of the FLUTOLANIL 70% GRANULE-treated rice seeds remained on plots (i.e., were unconsumed) during the 3-day study. On average, blackbirds consumed more than 65% of control seeds on these sites (FIG. 4). Thus, blackbirds consumed less treated than untreated rice within fields where seed had been broadcast aboveground.

Results: Field Evaluation of Drilled Seed

The number of emergent rice seedlings associated with drilled seed treated with 1% FLUTOLANIL 70% GRANULE averaged 9.6 and 10.2 seedlings within exclosed (birds absent) and non-exclosed (birds present) subplots. In comparison, seedlings associated with untreated seed averaged 8.4 and 5.0 seedlings within exclosed (birds absent) and non-exclosed (birds present) subplots. No difference in the number of emergent seedlings was observed between treated and untreated plots (i.e., among all subplots; F_{1.10}=2.13, P=0.17). Similarly, no difference in seedling numbers was observed within enclosed and non-enclosed subplots (i.e., among all plots; F_{1.10}=2.95, P=0.12).

Interestingly, however, a treatment-by-enclosure interaction was observed (F_{1.10}=6.25, P=0.03), whereby more treated seedlings were observed than untreated seedlings within non-exclosed (i.e., unprotected) subplots (P<0.05). Thus, the seed treatment of 1% FLUTOLANIL 70% GRANULE produced more seedlings within an experimental rice field associated with bird depredation.

The invention may further be practiced by providing flutolanil-treated bait either alone or in proximity to bird-consumption products at bird gathering places. To the extent that birds will have an aversion to the bait, and, therefore, find the gathering place less desirable, repulsion and control can be achieved.

In terms of application rates for use of the invention in the field, it will be understood by those skilled in the art that the rate will depend on the specific formulation used, the seed or plant to be treated, and/or regulatory requirements. For example, the labeled rate of flutolanil 70% granule is 0.5-1 lb per acres with a restriction to not apply more than 1.43 lb/acre per season. For flutolanil 2SC, the rate is 11.2-24 oz per acre with a restriction to not apply more than 32 oz/acre per year per season. Residual control would be dependent on rate as the tests indicated there is a rate. response. Optimum rate for each crop or site would have to be determined though controlled testing.

Thus, application of flutolanil to immature fruit, vegetables, or seedlings may be accomplished according to the invention to provide bird repellency at a point much earlier or later than flutolanil would be applied as a fungicide depending on the plant part to be protected.

Moreover, flutolanil compositions of the invention may be combined with other agrochemicals. For example, flutolanil may be used as slurry to use as a seed treatment based on desirable physical properties, such as better dispersion and more uniform application.

In accordance with the method of the invention and examples thereof described above, the following references are cited by way of background.

Table 1: Literature Cited

Avery, M. L., J. S. Humphrey, T. M. Primus, D. G. Decker, A. P. McGrane. 1998. Anthraquinone protects rice seed from birds. Crop Protection 17: 225-230.
Avery, M. L., S. J. Werner, J. L. Cummings, J. S. Humphrey, M. P. Milleson, J. C. Carlson, and T. M. Primus. 2005. Caffeine for reducing bird damage to newly seeded rice. Crop Protection.
Besser, J. F. 1985. A grower's guide to reducing bird damage to US. agriculture crops. National Wildlife Research Center Report 340 (Unpublished)
Cummings, J. L., M. L. Avery, O. Mathre, E. A. Wilson, D. L. York, R. M. Engeman, P. A. Pochop, and J. E. Davis, Jr. 2002. Field evaluation of Flight Control™ to reduce blackbird damage to newly planted rice. Wildlife Society Bulletin 30: 816-820.
Decker, D. G. and M. L. Avery. 1990. Reducing blackbird damage to newly planted rice with a nontoxic clay-based seed coating. Proceedings Vertebrate Pest Conference 14: 327-331.
SAS Institute, Inc. 1999. SAS/STAT User's Guide, Version 8. SAS Institute, Cary, N.C., USA.
Werner, S. J. and L. Clark. 2003. Understanding blackbird sensory systems and how repellent applications work. Management of North American Blackbirds Symposium. Bismarck, N.D., USA.
Werner, S. J., H. J. Homan, M. L. Avery, G. M. Linz, E. A. Tillman, A. A. Slowik, R. W. Byrd, T. M. Primus, and M. J. Goodall. 2005. Evaluation of Bird Shield™ as a blackbird repellent in ripening rice and sunflower fields. Wildlife Society Bulletin.
Wilson, E. A. 1985. Blackbird depredation on rice in southwestern Louisiana (Thesis). Louisiana State University, Baton Rouge, La. 91 pp.

Various changes in the details and components that have been described may be made by those skilled in the art within the principles and scope of the invention herein described in the specification and defined in the appended claims. Therefore, while the present invention has been shown and described herein in what is believed to be the most practical and preferred embodiments, it is recognized that departures can be made therefrom within the scope of the invention, which is not to be limited to the details disclosed herein but is to be accorded the full scope of the claims so as to embrace any and all equivalent processes and products. All references cited in this application are hereby incorporated by reference herein.

What is claimed is:

1. A method of bird aversion, comprising the step of:
repelling said bird by treating a bird-consumption product with a formulation comprising an effective amount of flutolanil.

2. The method of claim 1, wherein said step of repelling includes treating a seed.

3. The method of claim 2, wherein said seed comprises bait grain.

4. The method of claim 2, wherein said seed is a rice seed.

5. The method of claim 1, wherein said bird-consumption product is a seedling.

6. The method of claim 1, wherein said bird-consumption product is a fruit or vegetable.

7. The method of claim 1, wherein said flutolanil formulation comprises between 0.25 to 2 percent weight/weight of flutolanil.

8. The method of claim 1, wherein said step of treating a bird-consumption product is performed prior to planting said product.

9. The method of claim 1, wherein said step of treating further includes providing an agrochemical agent in combination with said flutolanil.

10. The method of claim 9, wherein said agrochemical agent is an anti-transpirant in admixture with said flutolanil.

11. The method of claim 1, wherein said step of repelling said bird by treating a bird-consumption product comprises applying an effective amount of flutolanil in proximity to said bird-consumption product.

12. The method of claim 1 1, wherein said step of applying an effective amount of flutolanil in proximity to said bird-consumption product comprises providing flutolanil-treated bait.

13. A method for rendering seedlings less palatable to birds, comprising the steps of:
(a) applying a composition to a seed including an amount of flutolanil effective to repel birds; and
(b) planting said seed, wherein said seedling resulting from the seed in step (a) provides bird-repellency effects.

14. The method of claim 13, wherein said seed is a rice seed.

15. The method of claim 13, wherein said amount of flutolanil comprises between 0.25 to 2 percent weight/weight.

16. The method of claim 13, wherein said step of treating further includes providing one or more agrochemical agents in combination with said flutolanil.

17. The method of claim 16, wherein said agrochemical agent provided is an anti-transpirant in admixture with said flutolanil.
